(19) United States
(12) Patent Application Publication
(10) Pub. No.: US 2026/0227008 A1
(43) Pub. Date: Aug. 6, 2026

(54) Stacking Arrangement Having a Clamping Component for a Clamp for Fastening Elongated Objects

(71) Applicant: ICOTEK PROJECT GMBH & CO. KG, Eschach (DE)

(72) Inventors: Valentin Ehmann, Mögglingen (DE); Bruno Ehmann, Schwäbisch Gmünd (DE)

(21) Appl. No.: 19/152,685

(22) PCT Filed: Feb. 5, 2024
(86) PCT No.: PCT/EP2024/052741

§ 371 Date: Aug. 26, 2025

(30) Foreign Application Priority Data
Feb. 3, 2023 (DE) 10 2023 102 652.6

(51) Int. Cl. F16L 3/22; F16L 3/10

(52) U.S. Cl. CPC F16L 3/222; F16L 3/1091

(57) ABSTRACT

The invention relates to a clamping component for a clamp for fastening elongated objects between at least two of the clamping components or between at least one of the clamping components and at least one counterelement, having at least one depression extending in a longitudinal direction.

The clamping component according to the invention is characterized by two pairs of bores arranged parallel to the longitudinal direction and one behind the other, wherein the pairs of bores are arranged transversely to the longitudinal direction on different sides of the depression, wherein each of the pairs of bores has a through-bore and a threaded bore, wherein the through-bores of the two pairs of bores are arranged on the same side in the longitudinal direction.

Clamps made from such clamping components or having at least one of these clamping components are ideal for forming a stacking arrangement of clamping components or clamps, e.g. for cables or cable bundles.

The invention relates to a stacking arrangement having at least two clamping components for a clamp for fastening elongated objects, such as cables, hoses, or pipes, of the type defined in more detail below.

Clamps for fastening elongated objects such as cables, pipes or hoses are known from the prior art. They usually consist of two clamping components and are used to fasten such elements to the surface of a base element, for example cables to a base plate, hydraulic lines to components or the like.

A very basic variant of such cable clamps is described, for example, in DE 1 889 445 U, wherein the cover or upper part typical of such clamps is latched as the first clamping component with the base or lower part as the second clamping component, in this case via tooth strips. The cable is clamped between the clamping components. In addition, comparable clamps are also known in which the upper part and the lower part are connected to each other by screws. The screws are then located at the point of the tooth strips, i.e., to the right and left of a passage for the pipe or cable. This passage is typically formed by two depressions in the two clamping components of the clamp, which face each other and run in the longitudinal direction.

For further information on the prior art, reference can be made to DE 20 2005 019 311 U1. Here, the cover part is omitted so that the cable or an empty conduit for cables is simply clipped into the lower part due to its elastic properties, but is not clamped between two separate components. In addition, a variant is described here in which these cable clamps can be connected to adjacent cable clamps via essentially H-shaped connectors transverse to the direction of travel of the cable.

Finally, reference can also be made to WO 2020/068869 A1. The cable clamp described there has a design in which the cables can be stacked, i.e., placed on top of each other transversely to the direction of travel and perpendicular to the surface on which the first cable clamp is attached. This creates a kind of “stack or tower” of individual cable clamps on top of each other. The structure is relatively “unstable” due to the plug connection described, so that only light cables or similar items can be secured against relatively small forces acting on them.

A cable clamp having clamping components screwed together is known from US 2018 7 0 066 772 A1. Similar designs are also shown in U.S. Pat. No. 2,937,835 A and DE 90 03 030 U1. U.S. Pat. No. 3,216,683 A describes a comparable configuration for fastening the cable clamps on top of each other.

DE 749 654 C shows a cable clamp having an intermediate element for clamping two cables.

US 2014/0 248 086 A1 shows a clamp that can be placed around a pipe.

It is now the object of the present invention to provide a stacking arrangement including clamping components for a clamp for fastening elongated objects, which is an improvement on the prior art and enables any number of clamps installed therein to be stacked on top of each other in an optimized manner.

According to the invention, this object is solved by a stacking arrangement of a plurality of such clamping components with the features discussed below. Advantageous designs and further developments result from the dependent subclaims.

The clamping component according to various implementations of the invention for a clamp for fastening elongated objects between at least two of these clamping components or between at least one of the clamping components and a counterelement has at least one depression extending in the longitudinal direction. The depression and a surface or depression facing it in the counterelement or the other clamping component form a passage running in the longitudinal direction between the parts. This passage serves to accommodate the elongated object, for example a cable, a cable bundle, an empty conduit, a pipe, a hose line, or the like. Its direction of travel in the area of the clamping component defines the longitudinal direction, wherein the clamping component itself typically extends with its greater dimension transverse to this longitudinal direction.

The clamping component now has two pairs of bores arranged one behind the other parallel to this longitudinal direction. On each side of the depression or through-opening, two bores are therefore provided in succession in the longitudinal direction, which form the respective pair of bores. One pair of bores and the other pair of bores are located transversely to the longitudinal direction on different sides of the depression. Each of the pairs of bores comprises a through-bore and a threaded bore. The through-bores of the two pairs of bores are arranged in the longitudinal direction on one side and the threaded bores of the pairs of bores are arranged in the longitudinal direction on the other side. Both the through-bores on one side and the threaded bores on the other side are therefore always on the same side of the clamping component when viewed in the longitudinal direction.

A stacking arrangement of two of these clamping components now results in a clamp that can be used in the conventional manner. According to a first design, the stacking arrangement according to the invention provides that a first clamping component forms an upper part and a second clamping component forms a lower part of the clamp for fastening elongated objects. Their depressions facing each other form the passage running in the longitudinal direction for clamping the elongated object or objects.

Typically, the lower part is fastened to a base element, such as a carrier, a plate, a rail, or the like, for example by being screwed into a specially provided opening in the center of the lower part. The upper part can then be fixed to the lower part by screws inserted into the through-bores and cooperating with the threaded bores of the lower part, whereby the elongated object is secured or clamped in the passage, which is increasingly closed. The lower part could also be fastened using two screws in its through-bores, each of which interacts with a thread in the base element or a nut located under the base element. Furthermore, two or more parallel passages running in the longitudinal direction could of course be provided next to each other for several elongated objects. The clamping component serving as the upper part is then rotated 180° relative to the lower part so that its through-bores, which are located at the front in the longitudinal direction, for example, coincide with the threaded bores located at the front in the longitudinal direction in the lower part.

Alternatively, the upper part and the lower part can also be screwed together with the base element. For this purpose, the upper part is not rotated relative to the base part so that their through-bores are aligned. Two screws arranged in these aligned through-bores of the upper part and the lower part are then screwed into a thread in the base element or a nut located under the base element to fasten the clamp made up of the two clamping components as a whole. This saves screws and, above all, assembly time, but also costs and weight.

In all three fastening variants, the upper part is ultimately braced relative to the lower part and thus clamps the elongated object in the passage between the clamping components.

However, the particular advantage lies in the stackability of clamps made from such clamping components. For this purpose, a first clamp is connected to a base element, to which the lower part is connected to the base element, e.g. in accordance with one of the alternatives described above, for example by screwing, locking or riveting. The upper part can then, unless the entire clamp is connected in this way, be placed on the lower part and fixed in the manner described above. Either a second clamp, rotated by 180° with respect to the longitudinal direction, is then placed on this first clamp, or the lower part of such a second clamp is placed on it. The second clamp as a whole or first only its lower part is then screwed to the upper part of the first clamp below by inserting screws through the through-bores of the second clamp or the lower part of the second clamp and screwing them into the threaded bores of the upper part of the first clamp. If the upper part of the second clamp has not been fastened at the same time, it can then be rotated 180° onto the lower part and screwed to it in the manner described above. Further clamps can then be stacked and fastened in the same way.

In this case, the same screws are always required to fasten the next higher clamp. This means that no particularly long screws are required. Furthermore, the lower clamp does not need to be loosened in order to fasten a clamp above it. A clamp arranged further up can therefore also be fastened retrospectively to one or more clamps that have already been mounted, which is a considerable advantage during assembly and subsequent repair, as the elongated objects inserted into the lower clamps do not have to be loosened.

An alternative variant of the stacking arrangement according to the invention may also provide that at least one clamping component is combined with a cover part and a base part. The interposed clamping component, which could also be referred to as an intermediate part, then has depressions extending in a longitudinal direction on two opposite sides, and the at least one clamping component is arranged between the cover part and the base part and screwed to these so that passages located above and below the clamping component are formed, each having the function of a clamp. The stacking arrangement can thus accommodate one or more clamping components according to the invention as intermediate parts between the base part and the cover part, which are not designed as clamping components according to the invention, in order to form a stacking arrangement with the function of two or more stacked clamps.

According to a very advantageous further development of the stacking arrangement, it may be provided that the first clamp is formed by the base part or a lower part in the form of a clamping component and the lower half of a first intermediate clamping component or intermediate part, wherein the second clamp is formed by the upper half of the intermediate part and the lower half of a further intermediate clamping component, the cover part or the upper part is formed in the form of a further clamping component according to the invention.

The intermediate part then forms the upper part for the lower clamp and can interact, for example, with a first lower part or a base part. Its upper design would then simultaneously form the lower part for the next clamp to be placed on top, which in turn could be closed off by such an intermediate part as the upper part or, if it is the last clamp in the stack, by an upper part in the form of a clamping component according to the invention or a separate cover part, so that there are no protruding edges at the top of the stack which could be a potential source of injury.

This advantageous further development of the stacking arrangement according to the invention can therefore also provide that the bottom part is replaced by the base part when an intermediate clamping component is used. It can, for example, be screwed to the base part via a central bore and then only has the two threaded bores instead of the pair of bores of the bores. One or more intermediate parts with their respective pairs of bores can then be attached to this in the same way as the lower and upper parts that form them. The stacking arrangement can then be completed either by another clamping component or by the special cover part. Similar to the base part, this cover part can dispense with the pairs of bores; instead, the two through-bores of the respective pair of bores are sufficient.

Another extremely advantageous design of the stacking arrangement provides that the threaded bores are formed by inserted, pressed-in or injected threaded elements. Such threaded elements can be, for example, metallic threaded elements such as nuts or the like. In addition to the design of the threads in the plastic material itself, which is also possible in principle, this increases the load-bearing capacity of the threaded bores in plastic clamps, so that higher screw forces can be applied and the clamps can be dismantled and reassembled several times without risking wear on the threads that would impair their function. Alternatively, the threaded bores could also be designed so that the threads are formed during assembly by screwing in self-tapping screws. The threaded bore would have to be designed for this purpose in terms of its diameter and the material provided on its walls. For example, the through-bores could have a larger diameter through which the screws can be pushed, and the threaded bores could have a smaller diameter so that the screws cut into themselves and thereby form the thread.

A further advantageous design may also provide that the cover parts, the base parts and/or the clamping components have T-shaped grooves on their sides transverse to the direction of travel outside the bores, which are designed to accommodate H-shaped connecting elements. Such connecting elements can therefore be used in a similar way to the above-mentioned prior art in the edge area of the clamping components or stacking arrangement according to the invention in order to connect them transversely to the direction of travel when, for example, individual stacks are built up adjacent to one another. This creates a very compact and stable structure which can also absorb higher tensile forces on the elongated objects located further up in the stacking direction very well.

Another very advantageous variant of the stacking arrangement according to the invention provides that the lower part or the base part below the lower half of the passage has a recess. Such a recess below the lower half of the passage can serve in particular to prevent the lower part from standing up over its entire surface when fastened to a base element, but only in its edge areas, in order to achieve the best possible contact in these important areas and to prevent the risk of full-surface contact, which in practice could always lead to contact at only a few points and thus to tilting. Rather, the recess, which is designed in the manner of a bridge, allows contact to be made on two comparatively small surface areas, so that reliable contact with one surface of the base element is ensured.

The upper part can accordingly have an elevation above the passage. This elevation corresponds to the recess so that, when a lower part is positioned on an already mounted clamp, the elevation engages in the recess, thus creating a compact structure. In addition, the elevation typically protrudes above the screw heads in order to create a structure that is relatively even at the top and does not have the screws as the highest points, which could otherwise be easily damaged mechanically, for example, damaged or sheared off by unwanted forces, which would lead to failure of the entire clamp.

Guide elements can be provided in the upper part, the cover part, the clamping component, the base part, and the lower part, which guide them into their positions relative to each other when the respective upper part is attached. Such guide elements serve to stabilize the position. They can be designed so that different cable diameters can be accommodated in a single passage. This allows the variety of parts required to be reduced accordingly by offering them, for example, for specific groups of diameters of the elongated objects, for example from 5 to 15 mm, from 12 to 25 mm, from 20 to 30 mm, etc. The term “diameter” should not be limited to a round cross-section of the elongated object; rather, any cross-sectional shapes are conceivable here, e.g., flat cables, cable bundles, rectangular hollow tubes, or similar.

According to an advantageous design of the structure according to the invention, it may also be provided that the lower part or the base part has a central bore which is designed as an elongated hole. Such a central bore designed as an elongated hole, which is aligned in particular transversely to the direction of travel, allows the lower part or base part to be fastened with a certain degree of flexibility with regard to the exact arrangement relative to the base element, which has, for example, a threaded bore or a weld nut. A screw can then be inserted through the elongated hole to fasten the lower part or base part, wherein lateral displacement and angle adjustment are still possible to a certain extent through the elongated hole.

A particularly advantageous design may also provide for a countersink around the central bore. This may be stepped or chamfered and may be used to accommodate a nut, a threaded sheet metal part or a welding pin protruding through the central bore for fastening the lower part or base part.

Adjacent to this central bore, at least one support element may be formed on the lower part or base part, which extends to a lower contact surface of the lower part. This makes it possible to transfer the forces of the screw not completely via the walls of the passage and the lateral contact surface transverse to the direction of travel to the right and left of the recess, but via such a support element. In a very advantageous further development, the support element can be designed as a circumferential chimney.

The upper part may, according to a very advantageous design, have a central opening which is designed to accommodate this at least one support element. This central opening allows, on the one hand, when the clamp is already closed and no elongated object is inserted, access to the screw with which the lower part is fastened to the base element and, on the other hand, allows the support element to be received, thus enabling stackability.

Further advantageous designs of the clamp according to the invention or the stacking arrangement of such clamps according to the invention are also apparent from the exemplary embodiment described in more detail below with reference to the figures, wherein:

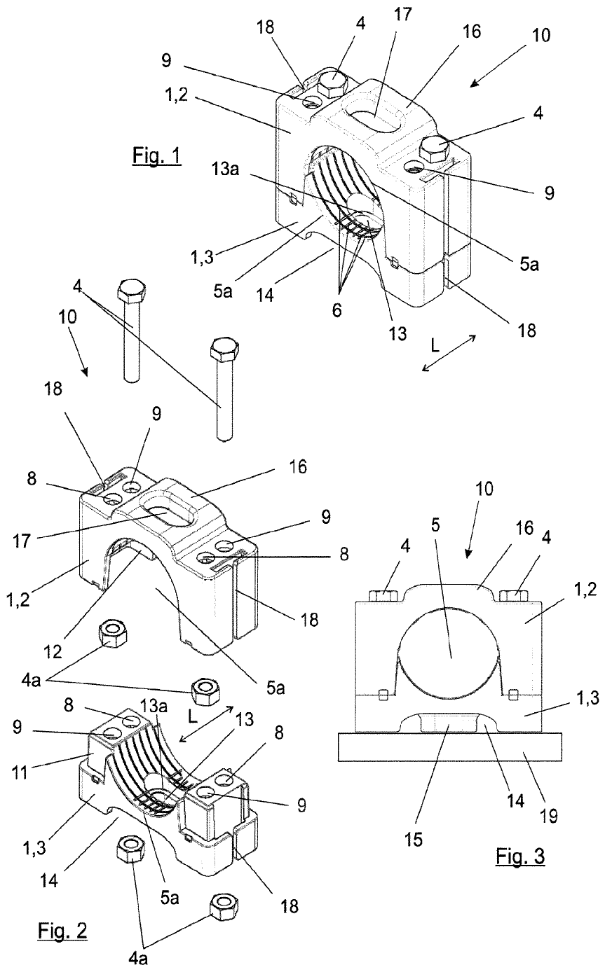

FIG. 1 shows a three-dimensional representation of a possible embodiment of a clamp consisting of two clamping components;

FIG. 2 shows an exploded view of the clamp from FIG. 1;

FIG. 3 shows a side view of the clamp from FIG. 1;

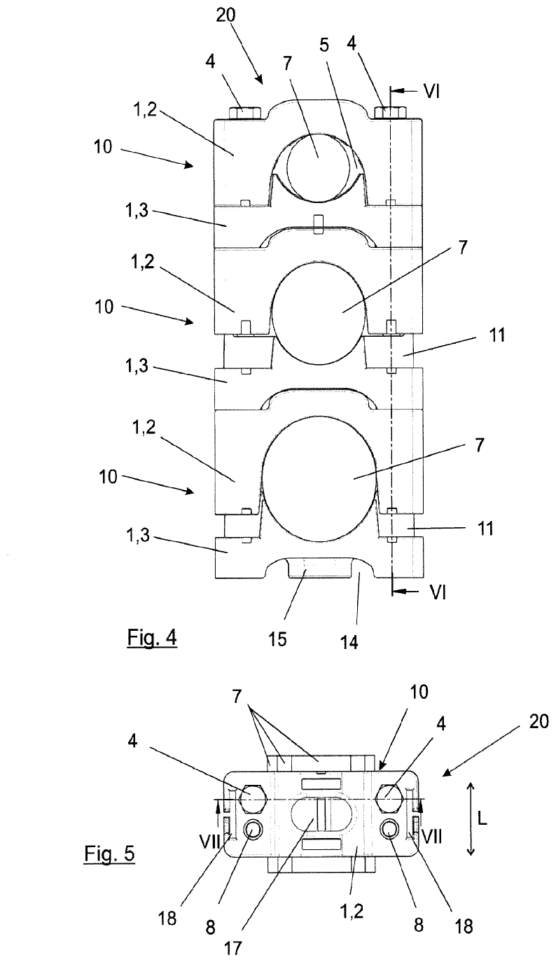

FIG. 4 shows a side view of a stacking arrangement of clamps according to the preceding figures;

FIG. 5 shows a top view of the stacking arrangement according to FIG. 4;

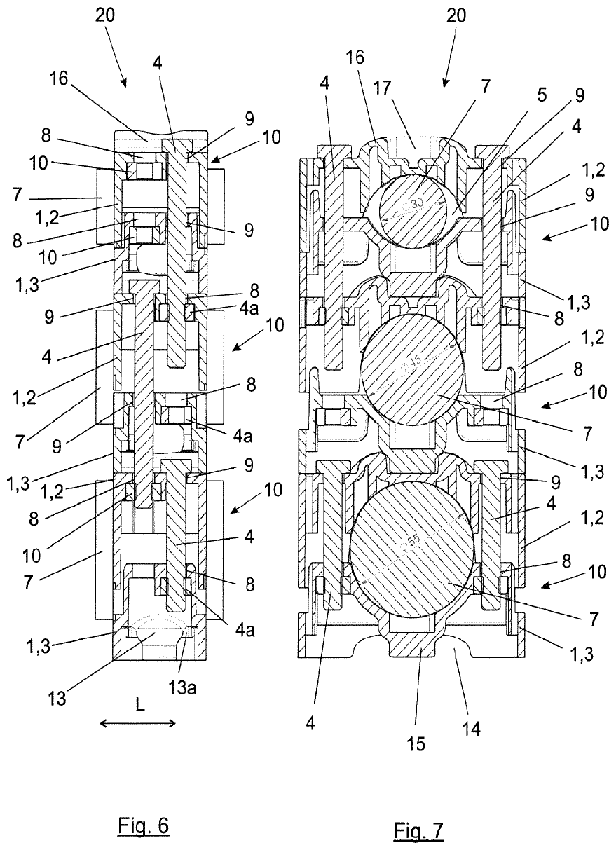

FIG. 6 shows a sectional view of the stacking arrangement according to line VI-VI in FIG. 4;

FIG. 7 shows a sectional view of the stacking arrangement according to line VII-VII in FIG. 5;

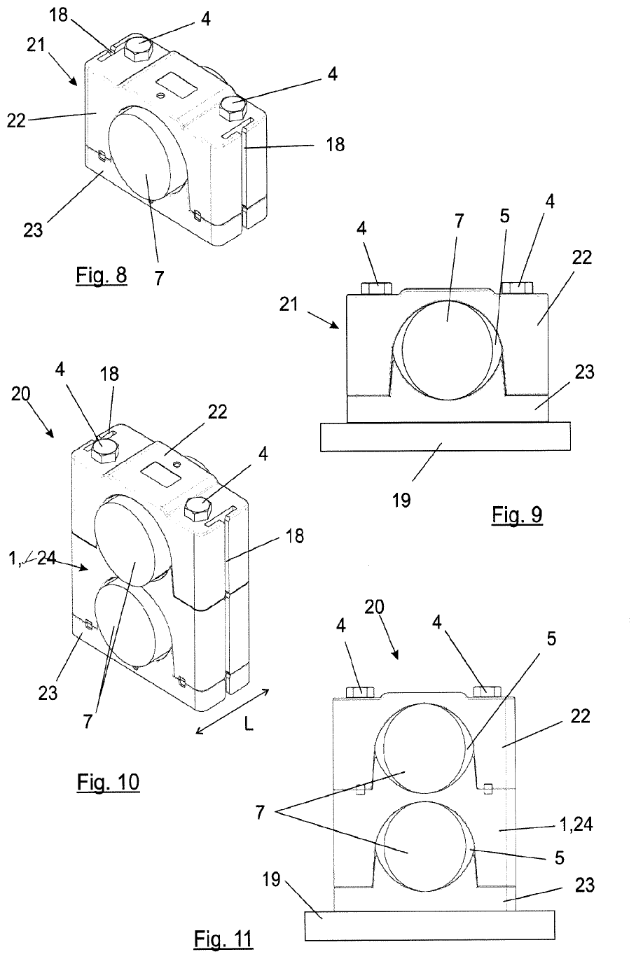

FIG. 8 shows a three-dimensional view of an embodiment of a conventional clamp;

FIG. 9 shows a side view of the clamp according to FIG. 8;

FIG. 10 shows a stacking arrangement according to the invention using the conventional clamp according to FIG. 8 and FIG. 9 and a clamping component designed as an intermediate part in a three-dimensional view;

FIG. 11 shows a side view of the representation in FIG. 10;

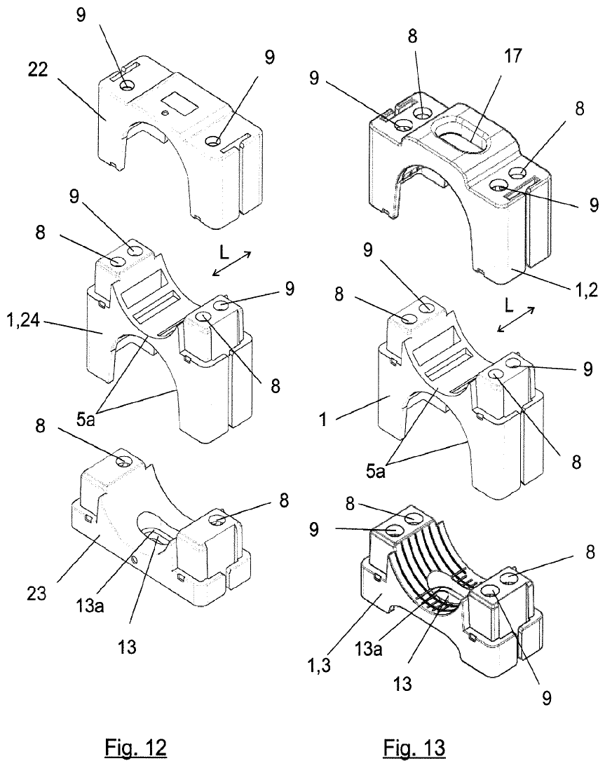

FIG. 12 shows an exploded view of the three parts installed in the stacking arrangement according to FIG. 10 and FIG. 11;

FIG. 13 shows an exploded view of three installed parts in the stacking arrangement with an upper part and a lower part according to FIG. 1ff.;

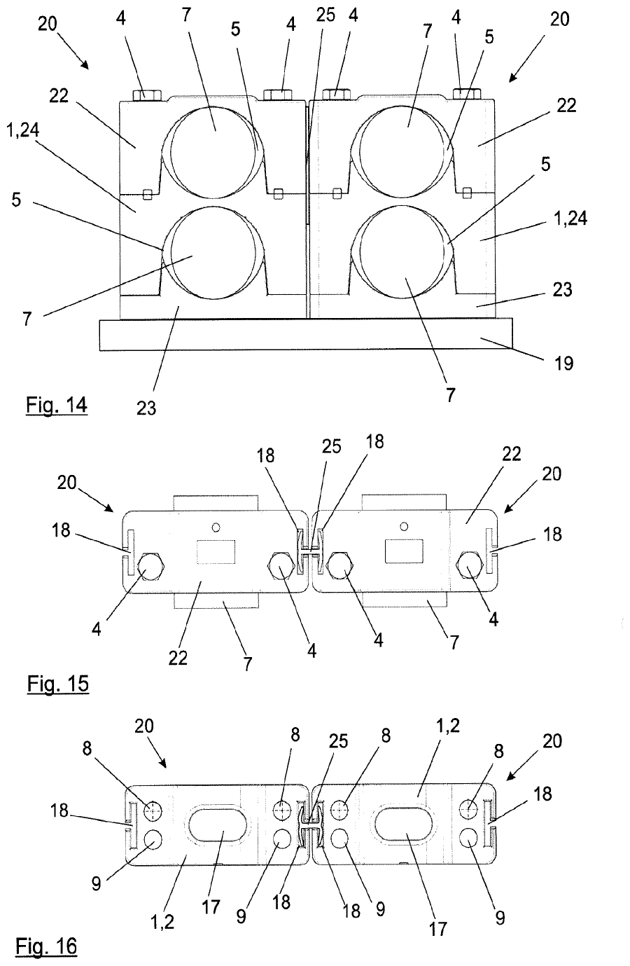

FIG. 14 shows a side view of two stacking arrangements according to FIG. 11 next to each other;

FIG. 15 shows a top view of the arrangement according to FIG. 14; and

FIG. 16 shows a representation analogous to that in FIG. 15 with two stacking arrangements according to FIG. 4 and FIG. 5.

FIG. 1 shows a three-dimensional view of a clamp 10 for fastening an elongated object not shown here, such as a cable, a hydraulic line, a cable bundle, or the like. The clamp 10 consists of two clamping components 1, one of which forms an upper part 2 and one of which forms a lower part 3. These are connected to each other by two screws 4.

As can be seen from the exploded view in FIG. 2, both the upper part 2 and the lower part 3 have depressions 5a in the form of half-shells, which together form a passage 5 for receiving the elongated object between the upper part 2 and the lower part 3. Individual transverse and longitudinal ribs 6 can be seen in this passage 5, which are intended to increase friction against the elongated object 7 (see, for example, FIG. 4ff) so that said object is better fixed in the clamp 1. The transverse ribs 6 thus improve the tensile strength in the clamp 10, while the longitudinal ribs 6 counteract torsion of the elongated object 7. The elongated object 7 then runs along a longitudinal direction designated L through the passage 5 formed between the upper part 2 and the lower part 3.

Each of the two clamping components 1 now has a pair of bores 8, 9 transversely to the longitudinal direction L adjacent to the respective depression 5a or the passage 5. This applies to both the upper part 2 and the lower part 3. Of this pair of bores 8, 9, one bore, here bore 8, is designed as a threaded bore 8, while the other bore, here bore 9, is designed as a through-bore 9. The design as a threaded bore 8 is exemplarily realized here in such a way that metallic threaded elements, which are realized here in the form of screw nuts 4a, are pressed into the area of the threaded bores 8 from below.

It is now crucial that both in the upper part 2 and in the lower part 3, the two threaded bores 8 of the bore pairs 8, 9 are arranged on the same side in the longitudinal direction L. In the upper part 2, in the exemplary embodiment shown here, these are on the front left side in the longitudinal direction L, while in the lower part 3 it is exactly the opposite: here, the through-bores 9 are located at the front left in the longitudinal direction L and the threaded bores 8 are located at the rear right in the longitudinal direction L. If the upper part 2 and the lower part 3 are now connected to each other by means of the screws 4, as can be seen, for example, in FIG. 1 or in the side view of FIG. 3, these screws 4 protrude through the parts of the clamp 10 in the upper part 2 that are rotated by 180° relative to each other in the upper part 2 through the through-bores 9 and engage in the threaded bores 8 in the lower part 3, so that the upper part 2 and the lower part 3 can be screwed together via the screws 4 in order to clamp an elongated object 7, not shown here, in the passage 5. As can be seen from the exploded view in FIG. 2, guide elements are formed between the upper part 2 and the lower part 3, which are realized here as outwardly directed guide surfaces 11 of the lower part 3, which correspond to the corresponding inner surfaces 12 of the upper part 2, of which only one is visible here.

The lower part 3 also has a central bore 13, which can be seen in FIGS. 1 and 2 and which is designed as a long hole and serves, for example, to accommodate a screw for fastening the lower part 3 to a base element 19 (see, for example, FIG. 3), such as a plate or a rail. A stepped countersink 13a may be provided around the central opening 13, in which, for example, a nut or a fastening plate could be accommodated. Furthermore, in the particularly favorable embodiment of the clamp 10 shown here, a recess 14 is provided below the lower half of the passage 5. The lower part 3 is thus designed in the manner of a bridge which stands on the right and left, for example, on a plate as a base element 19, as can be seen in the side view of FIG. 3. A support element 15 is arranged around the central bore 13, which is designed in particular as a long hole. This support element 15 is designed as an oval chimney around the central bore 13 and serves to support the lower part 3 if it is screwed in place over the central bore 13.

The upper part 2 now has an elevation 16 that essentially corresponds to the recess 14 and is ideally designed so that it forms the highest point of the clamp 10 when assembled, i.e., it protrudes laterally beyond the heads of the two screws 4 in the central section to protect them from mechanical damage. As can again be seen from FIGS. 1 and 2, the upper part 2 has a central opening 17 which is designed to receive the support element 15 so that the clamps 10 can be stacked on top of each other in the manner described below.

In the illustrations in FIGS. 1 and 2, a T-shaped groove, designated 18, can also be seen on each side of the clamp 10, both in the upper part 2 and in the lower part 3, which will be discussed in more detail later.

FIG. 4 now shows a stacking arrangement 20 of three of the clamps 10 in the embodiment according to FIGS. 1 to 3. The clamp 10 shown at the bottom of FIG. 4 is designed to hold an elongated object 7, for example a cable with a diameter of 55 mm. The two clamps 10 arranged above are designed analogously and can accommodate cables with different diameters, for example from a small diameter of 30 mm shown above to a diameter of 55 mm shown below. FIG. 5 shows the corresponding structure from above.

The special feature of such a stacking arrangement 20 can now be seen in particular from the two sectional views in FIGS. 6 and 7, which are selected according to lines VI-VI and VII-VII in FIGS. 4 and 5. In FIG. 6, the lower part 3 of the lower clamp 10 is located at the very bottom, which is completed by the corresponding upper part 2 of this clamp 10. In the longitudinal direction L to the left, the through-bore 9 and, to the right of it, the threaded bore 8 of the pair of bores 8, 9 can be seen in the lower part 3. As shown in the previous figures, a screw 4 connects the upper part 2 to the lower part 3. The lower part 3 of the second clamp 10 is now arranged on top of this, in an identical arrangement with respect to its longitudinal direction L as the lower part 3 of the lowest clamp 10, i.e. also such that its through-bore 9 is arranged on the left in the longitudinal direction. The upper part 2 of this additional, middle clamp 10 is now not rotated relative to its lower part 3, as is the case with the lower clamp 1. This means that the through-bore 9 is also located on the left in the longitudinal direction L. The second clamp 10 can now be screwed through the through-bore 9 of its upper part 2 and its lower part 3 with the threaded bore 8 in the upper part 2 of the lowest clamp 1 using a longer screw 4. The middle clamp 10 can then be attached to the lowest clamp 10, which has already been screwed on and secured with the shorter screw 4, without having to loosen the lower clamp 10 again. The third uppermost clamp 10 is now rotated by 180° relative to the second middle clamp 10, wherein the upper part 2 and the lower part 3 are also arranged in the same orientation with respect to the longitudinal direction L, so that here too, the upper part 2 and the lower part 3 can be screwed together through their through-bore 9 with the threaded bore 8 in the upper part 2 of the middle clamp 10 using a longer screw 4. In the illustration in FIG. 7, the same structure can be seen again in a sectional view transversely to the longitudinal direction L, wherein here, accordingly, only the screw connection of the upper clamp 10 with the upper part 2 of the middle clamp 10 and of the upper part 2 and the lower part 3 of the lower clamp 10 are shown accordingly.

As an alternative to the fastening option shown here for such a stacking arrangement 20 of clamps 10, it would also be conceivable to already rotate the lower part 3 of the middle clamp 10 by 180° so that it can be fastened to the upper part 2 of the clamp 10 below, and then fasten the upper part 2 of this middle clamp 10 to the already fastened lower part 3, and so on. Another possibility is to connect the lowest clamp 10 through its through-bore 9 to the base element 19 not shown here, wherein this connection can also be made via the central bore 13 of the lower part 3 of the lower clamp 10.

Two clamping components 1, each designed as a lower part 3 and an upper part 2, can thus be used to create a single clamp 10. This clamp 10 made from two of the clamping components 2, 3 then enables a very efficient stacking arrangement 20.

A similar stacking arrangement 20 with even fewer components can also be achieved using a substantially conventional clamp 21, as can be seen in the three-dimensional view and side view shown in FIGS. 8 and 9. This conventional clamp 21 consists of a cover part 22 and a base part 23, which form the passage 5 for accommodating the elongated object 7 between them. The cover part 22 comprises only a through-bore in which two screws 4 are arranged, and the bottom part 23 comprises two threaded bores, which are not visible here, in which the screws 4 are screwed in. This structure also has a T-shaped groove 18 on the sides of this clamp 21.

FIG. 10 now shows a stacking arrangement 20 in which such a conventional clamp 21 is used as the start and end part. The base part 23 is followed here by an intermediate part 24 in the form of a clamping component 1, which, instead of the clamping components 1 described above, has depressions 5a running on two opposite sides in the longitudinal direction L, before the stacking arrangement 20 is closed by the cover part 22. Using a base part 23 and cover part 22 constructed in the conventional manner, the stacking arrangement 20 can then be implemented by means of the intermediate part 24.

As can be seen in the exploded view in FIG. 12, this intermediate part 24 has the two depressions 5a for forming the respective passage 5 in the stacking arrangement 20, as well as the pairs of bores 8, 9 transversely to the longitudinal direction L adjacent to the passage 5, of which the two bores arranged in the longitudinal direction L on one side form threaded bores 8 and the two bores arranged in the longitudinal direction L on the other side form through-bores 9. This allows the structure to be positioned so that the intermediate clamping component 1 or intermediate part 24 can be screwed into the threaded bores 8 of the base part 23 via the through-bores 9, and that the cover part 22 or also a further intermediate part 24 placed on top can be screwed in place with the corresponding threaded bores 8 of the intermediate part 24 or of the intermediate part 24 lying below. This also allows a stacking arrangement 20 to be formed for fastening, for example, the two elongated objects 7 of FIG. 10ff., but also several elongated objects analogous to the arrangement shown in FIG. 4ff.

The intermediate part 24 can of course also be combined with the lower parts 3 and the upper parts 2 with the respective pairs of bores 8, 9, as shown in FIG. 13. In addition, several intermediate clamping components 1 can be used one above the other. In principle, a stacking arrangement 20 consisting only of the intermediate parts 24 would also be conceivable.

In both FIG. 12 and FIG. 13, the intermediate part 24 is screwed to the base part 23 or the lower part 3. The cover part 22 or the upper part 2 is then placed on this structure and screwed to the intermediate part 24. With the intermediate part 24 rotated by 180° so that its threaded bores 8 are on the left front, all three parts 2 or 22, 24, 1, and 3 or 23 can also be connected together using only two (longer) screws.

The illustration in FIG. 14 now shows two stacking arrangements 20 according to FIG. 10, 11, or 12 next to each other. In the top view according to FIG. 15, it can be seen that these two stacking arrangements 20, which are adjacent to each other transversely to the longitudinal direction L, can be connected to each other via a substantially H-shaped connecting element 25 in order to achieve improved stability of the two stacking arrangements 20. For this purpose, the connecting element 25 is inserted into the T-shaped grooves 18 of two adjacent stacking arrangements 20. The curved design of the two legs of the connecting element 25 ensures good contact with the T-shaped groove 18. This securely fixes the stacking arrangements 20 against each other. The connecting element 25 can be used in different lengths and can also be used multiple times across the height of the two stacking arrangements 20. It ensures a lateral connection between the stacking arrangements 20, while their two base parts 23 are connected to the base element 19. Together, this creates a very stable structure that is also able to absorb tensile forces on the elongated objects 7.

As already mentioned at the beginning, the T-shaped grooves 18 provided for receiving the connecting elements 25 are also provided in the upper part 2 and the lower part 3 of the clamp 10 according to the invention, so that stacking arrangements 20 according to FIG. 4ff can also be connected to each other. The illustration in FIG. 16 picks up on this in the same way as the illustration in FIG. 15 and essentially shows two such stacking arrangements 20 analogous to those in FIG. 5, which are also connected via the H-shaped connecting element 25 in their T-shaped grooves 18.

1-15. (canceled)

16. A stacking arrangement having at least two clamping components for fastening elongated objects between them, which have at least one depression extending in a longitudinal direction and two pairs of bores of bores lying one behind the other parallel to the longitudinal direction, wherein the pairs of bores are arranged transversely to the longitudinal direction on different sides of the depression, wherein each of the pairs of bores has a through-bore and a threaded bore, wherein the through-bores of the two pairs of bores are arranged on the same side in the longitudinal direction, wherein, a first clamping component forms an upper part and a second clamping component forms a lower part of a clamp or fastening elongated objects, wherein their depressions facing each other form a passage extending in a longitudinal direction, which is suitable for accommodating the at least one elongated object;
wherein a first clamp made of one of the upper parts and one of the lower parts is connected to a base element, wherein either a second clamp, which is rotated by 180° with respect to the longitudinal direction, or the lower part of such a second clamp is placed on top of this first clamp, wherein the second clamp as a whole or its lower part is screwed to the upper part of the first clamp in that screws are guided through the through-bores of the second clamp or the lower part of the second clamp and are screwed into the threaded bores of the upper part of the first clamp, wherein, if only the lower part of the second clamp is fastened, its upper part is placed onto the lower part rotated by 180° and screwed into the threaded bores of the lower part via screws in its through-bores, and wherein further clamps can be attached and fixed in a similar manner.

17. The stacking arrangement according to claims 16, wherein the cover part, the base part and/or the at least one clamping component has T-shaped grooves on its sides lying outside transversely to the longitudinal direction, which are designed to accommodate connecting elements.

18. The stacking arrangement according to claims 16, wherein the base part or the lower part has a central bore which is designed as an elongated hole.

19. The stacking arrangement according to claims 18, wherein a countersink is arranged around the central bore.

20. The stacking arrangement according to claims 16, wherein the lower part or the base part has a recess below the lower depression of the passage, wherein the upper part has an elevation above the passage corresponding to the recess.

21. The stacking arrangement according to claims 20, wherein at least one support element is formed adjacent to the central bore, which extends to a lower bearing surface of the lower part or base part.

22. The stacking arrangement according to claims 21, wherein the support element is designed as a chimney surrounding the central bore.

23. The stacking arrangement according to claims 21, wherein the upper part has a central opening which is designed at least to accommodate the at least one support element.

24. The stacking arrangement according to claims 16, wherein the threaded bores have inserted, pressed-in or injected thread elements.

25. A stacking arrangement having a cover part and a base part as well as at least one clamping component for a clamp for fastening elongated objects between at least one of the clamping components and at least one counterelement, having at least one depression extending in a longitudinal direction, wherein two pairs of bores are provided by bores lying one behind the other parallel to the longitudinal direction, wherein the pairs of bores are arranged transversely to the longitudinal direction on different sides of the depression, wherein each of the pairs of bores has a through-bore and a threaded bore, wherein the through-bores of the two pairs of bores are arranged on the same side in the longitudinal direction;
wherein the clamping component has depressions extending in a longitudinal direction on two opposite sides, wherein the at least one clamping component is arranged between the cover part and the base part and screwed to these in such a way that passages are formed above and below the clamping component.

26. The stacking arrangement according to claim 25, wherein a first clamp is formed by the base part or a lower part and the lower half of a first intermediate part in the form of an intermediate clamping component, and wherein a second clamp is formed by the upper half of the intermediate part and the lower half of a further intermediate part, the cover part or the upper part.

27. The stacking arrangement according to claim 26, wherein the base part has the two threaded bores and the cover part has the two through-bores.

28. The stacking arrangement according to claims 25, wherein the cover part, the base part and/or the at least one clamping component has T-shaped grooves on its sides lying outside transversely to the longitudinal direction, which are designed to accommodate connecting elements.

29. The stacking arrangement according to claims 25, wherein the base part or the lower part has a central bore which is designed as an elongated hole.

30. The stacking arrangement according to claims 29, wherein a countersink is arranged around the central bore.

31. The stacking arrangement according to claims 25, wherein the lower part or the base part has a recess below the lower depression of the passage, wherein the upper part has an elevation above the passage corresponding to the recess.

32. The stacking arrangement according to claims 31, wherein at least one support element is formed adjacent to the central bore, which extends to a lower bearing surface of the lower part or base part.

33. The stacking arrangement according to claims 32, wherein the support element is designed as a chimney surrounding the central bore.

34. The stacking arrangement according to claims 32, wherein the upper part has a central opening which is designed at least to accommodate the at least one support element.

35. The stacking arrangement according to claims 25, wherein the threaded bores have inserted, pressed-in or injected thread elements.
